(19) United States
(12) Patent Application Publication
(10) Pub. No.: US 2008/0041301 A1
(43) Pub. Date: Feb. 21, 2008

(54) Band Processing Plant

(76) Inventor: Stefan Hein, Blankenbach (DE)

Correspondence Address: VAN DYKE, GARDNER, LINN & BURKHART, LLP, SUITE 207, 2851 CHARLEVOIX DRIVE, S.E., GRAND RAPIDS, MI, 49546, US

(21) Appl. No.: 11/596,508

(22) PCT Filed: May 25, 2004
(86) PCT No.: PCT/EP04/05618

§ 371 Date: Nov. 14, 2006

(51) Int. Cl. B05C 11/00

(52) U.S. Cl. 118/44

(57) ABSTRACT

The invention relates to a continuous processing system for processing continuous flexible substrates (17S), comprising: two winding stations (10; 10′) for unwinding and winding up the substrate; at least one processing station (B) situated, in the running path of the substrate, between both winding stations, and; lock valves (18), which are each located between a winding station (10; 10′) and the at least one processing station and which serve to maintain different pressure levels in the winding stations and in the at least one processing station. The winding station is mounted on a base (11) and can be retracted, i.e. for changing the substrate. According to the invention, the winding stations (10; 10′) and the processing station (B) are mounted in or on different bases that can move relative to one another. The base of the processing station is fixed and is provided as a part of a housing (1), which surrounds the processing station (B), and during operation, also surrounds the winding stations (10, 10′), and this housing contains the valves (18). The winding stations (10; 10′) are mounted in a frame (12), which surrounds their common base (11) and which has openings that can be closed off by the valves (18). During operation, this frame is accommodated inside the housing (1) of the processing station. The opened valves (18) can jointly evacuate the processing station (B) and the winding stations (10; 10′), and when the valves (18) are closed, the winding stations can be ventilated independent of the processing station.

The present invention relates to a band processing plant with the features of preamble of claim 1.

Processing plants of this type are mainly designed for coating flexible band substrates, such as, for example, plastics foils, magnetic tapes, films, etc. in vacuum (for example, by sputtering, i.e. target atomization, eventually reinforced by magnetic fields, evaporation, PVD or CVD processes), as well as for additional processing methods, such as pre-processing/cleaning/drying/surface activation/polymerization, etc. It is required, in such cases, to introduce into the plant the band substrates, supplied in the form of bales or foils, which are being placed upon a bearing axle, so that during the coating process, the band substrate may be unrolled from this bale.

Beyond/downstream from the coating chamber(s), another axle is provided with a take-up reel, upon which the coated band substrate is again being winded.

Basically, such a band coating plant may be split up into modules (unrolling, coating and take-up modules).

On known plants, both axes or cylinders, bilaterally mounted for unrolling and winding up said band substrate, are assembled on a common frame-like base, which offers the advantage that they are in a reciprocal constant and firm positional relationship. When both axes or cylinders are disposed on both sides of the coating module, during the exchange of spools it can be avoided, by means of separate measures, to ventilate also the coating chamber(s) operating in vacuum.

It should be aimed not to ventilate the coating chamber, operating in vacuum, at each exchange of the substrate bale, i.e. when removing from a band substrate a newly rolled up bale, which has just been coated.

It is, therefore, already known to mount air-lock valves between individual modules. The volume which is again to be ventilated, is thus clearly reduced, since only the admittance and the removal stations, respectively, are being ventilated and the effective coating chamber may permanently remain in an evacuated condition. Evidently, in case of need, the entire plant may be ventilated.

DE 197 35 603 C1 describes a continuous vacuum coating plant with different subsequently disposed coating chambers, where inside each coating chamber a roller frame is provided, comprising by-pass rolls, band measuring rolls and cooling rolls. The roller frames may be adjusted in such a fashion in their respective coating chamber that the rolls and cylinders of the subsequent chambers may be reciprocally adjusted. The magnetron sources of said coating chambers are assembled independently from the roller frames, so that they may both be adjusted and exchanged without having to alter the position of the cylinders.

The band substrate to be processed will be introduced from an unwinding chamber into the coating chambers and downwards from the latter will be introduced into a roll up or winding up, chamber, and between the unrolling and roll up chambers and the coating chambers, vacuum valves are provided, which will not be covered in detail.

DE 101 57 186 C1 describes another continuous vacuum coating unit from a subdivision into unroll, coating and roll up chambers, between which air-lock or band valves are provided. The spool shafts, provided inside the evacuable unroll and roll up chambers are provided on said roller frames, with are fixed independently from each other and may be separately moved out of the plant. On the contrary, the cylinders in the processing module are disposed on a common roller frame. For all roller frames, common fixation or deposition points are provided at the separating walls, between the roll up chambers and the processing module. Reciprocal displacements of roller frames during operation should be avoided during operation by providing, during operation, a maximum pressure differential of 50 Pa between roll up chambers and processing module. Said processing module may be closed with a separate cover, provided, on its turn, with access openings.

WO 99/50 472 describes a vacuum band coating plant, which comprises a loading respectively discharge station with corresponding winding and dewinding reels arranged in a common chamber and at least a separately provided reaction chamber (coating module). The band substrate passes through cylinder air-locks between loading and discharge stations, said cylinder air locks acting as pressure stages. In one version, it may pass between two cylinders rolling upon each other, and, in another version, it may pass between a cylinder and a fixed sealing block. These cylinder air-locks may be opened, in order to introduce, for example, a new band substrate. For this purpose, either one of the cylinders may be folded out, its rotary axis being mounted foldable around an axis of rotation, or the sealing block will be removed from the cylinder.

In one embodiment of this known plant, all cylinders and valves, with drives, are provided on a common basis, which may be introduced in a housing. The gaps between basis and housing may be closed vacuum-tight by means of circumferential seals. Nevertheless, in view of their spatial orders, especially in the area of said air-lock valves, not all these seals may be applied on plane sealing surfaces. Also in this plant, in view of the existence of said air-lock valves, the band spools may be exchanged, without having to ventilate said processing chamber.

The object of the invention consists in providing another processing plant, enabling a change of unwinding and roll up spools, without having to ventilate the entire plant, i.e. the evacuating processing section.

According to the invention, this task will be solved with the features of claim 1. The features of the dependent claims indicate advantageous embodiments of the invention.

According to the invention, roll up stations and processing stations are provided inside or upon different bases, which may be moved relatively to each other. The basis of the processing plant is a firm section of the plant housing, which also surrounds the winding up sections during operational conditions.

Winding up sections are provided in a structure, comprising its common basis and open towards the processing module, being moveable vis-à-vis the plant housing, and they may be sealed by valves against the actual processing plant (or processing module).

Preferably, the entire basis is a closed plate, forming a wall section of said structure. In an especially convenient embodiment, this basic plate of the winding up stations, during operational conditions, simultaneously forms a wall section of the housing of the overall plant. In addition, it forms a wall of a chamber, formed inside the structure itself, said chamber featuring essentially a closed format.

From the outside, the winding up stations may be accessed through separate openings of said plant housing, which during operational conditions may be tightly closed. To these openings correspond openings in the wall of the structure, bearing the winding up stations. After closing said valves and venting winding up stations, a quick exchange will thus be feasible of the band spools, without having to ventilate the entire plant and without having to extract the winding up stations from the plant housing.

In an especially preferred embodiment, the structure, or also the plant housing, comprises a sealing, surrounding the loading and/or unloading opening. This seal is advantageously operable through fluid pressure, so that it features a sealing and an inactive position. In the latter, the simple extraction and introduction of said winding up sections is feasible without exerting efforts upon said seal. In the sealed position, the respective opening may be used to change loading actions, without having to ventilate the entire plant. Advantageously, this seal may be applied against a plane internal wall of said housing and may be disposed at this wall, in order to be applied, in case of need, against a flange section of said structure.

Advantageously, the air-lock valves will be provided with an opening for traversing said band substrate and a body to close this opening, and the closed position of said body may also be used to retain said band substrate during the exchange of substrate spools or supports.

Other details and advantages of the object of the present invention may be seen in the drawing of an exemplary embodiment and based on the subsequent, detailed description.

The figures show, in simplified fashion:

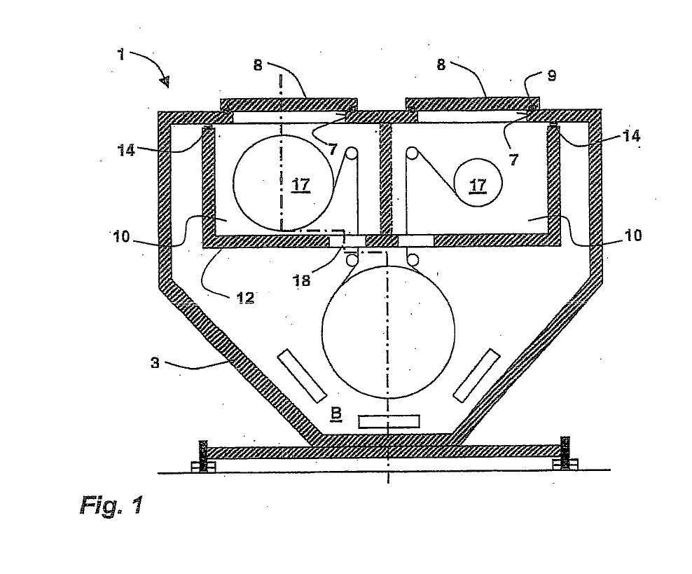

FIG. 1—a schematic basic drawing (cut section) of the entire continuous processing plant according to the invention;

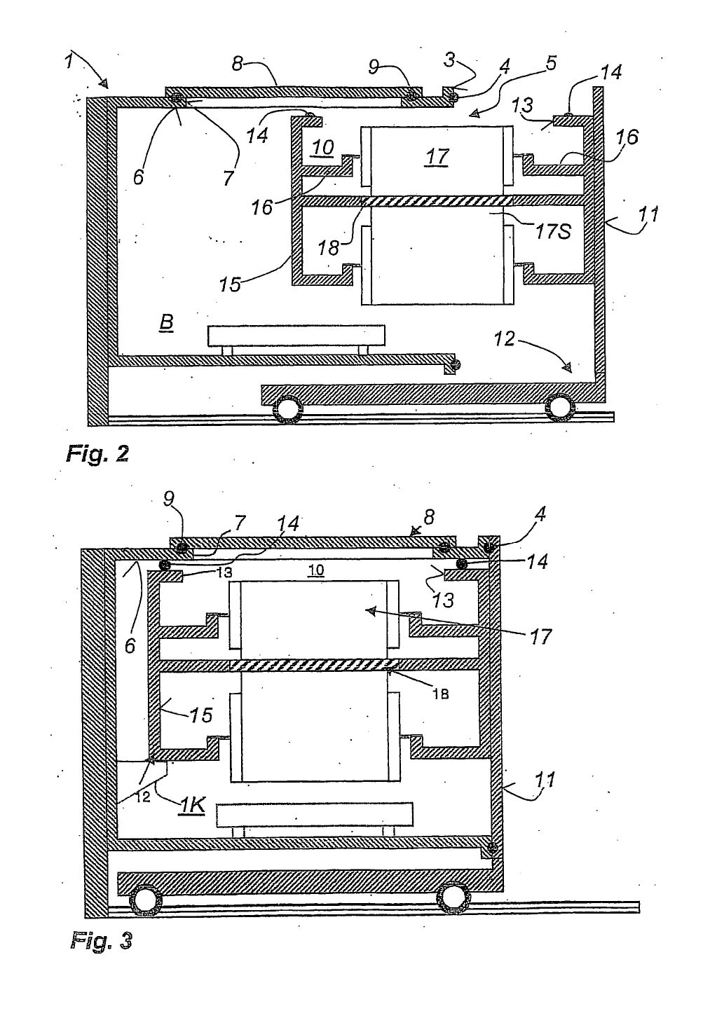

FIG. 2—a view of the same continuous processing plant, inclined in a 90° angle relative to FIG. 1, with a structure for winding up stations, in a position extracted from said housing;

FIG. 3—another view similar to FIG. 2, of said continuous processing plant with structure introduced into said housing, in its operating position;

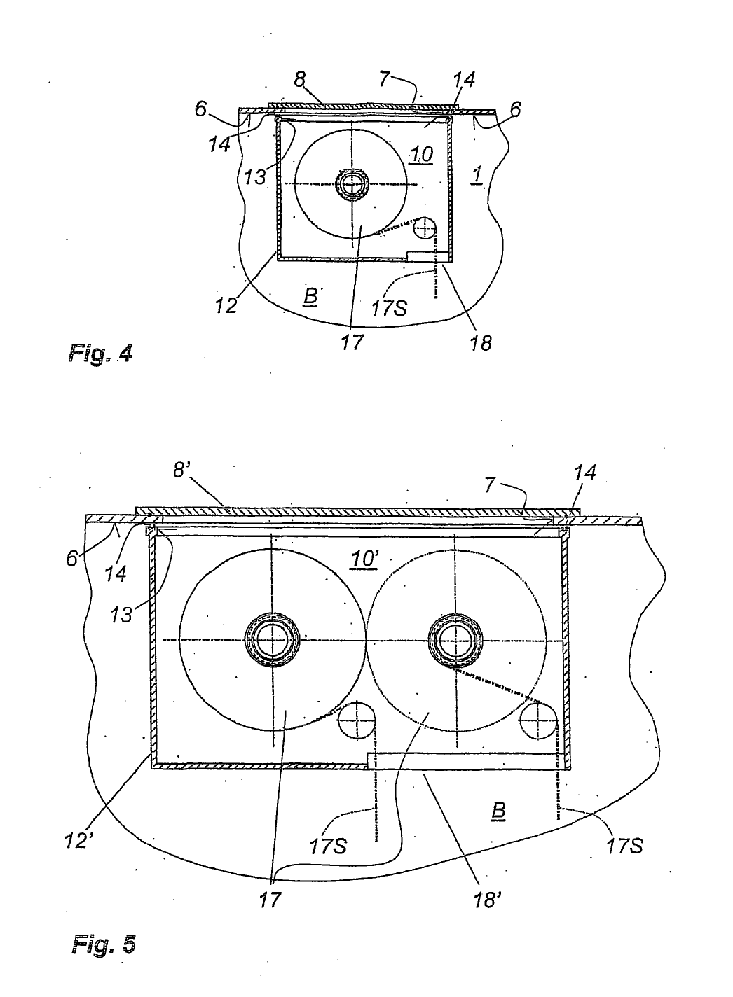

FIG. 4—a lateral view of a winding up station and of structure and housing, with an air-lock valve;

FIG. 5—a variant of FIG. 3, where two winding up stations are provided for winding up and unrolling in tandem fashion, and two air-lock valves are integrated into a unit;

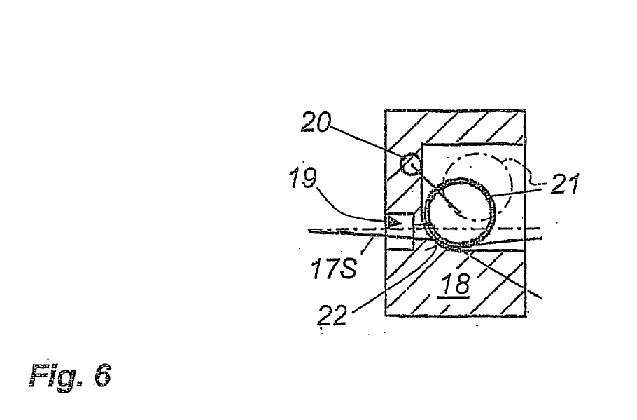

FIG. 6—a preferred embodiment of an air-lock valve.

FIG. 1 shows a housing 1 with a continuous processing plant, which may be evacuated by means not shown in detail. On one side, it features a large opening, surrounded by a flange 3 (in this view, one looks inside the opening). FIGS. 2 and 3 show the purpose of this main opening 5; it enables introduction and extraction of a structure 12 for winding up stations 10 and, therefore, of the entire stock of band material, which is to be processed in one processing step inside the plant. A surrounding seal 4 is provided on said flange 3.

At the bottom area of said housing 1, a processing set B is only indicated, which, for example, may comprise at least one sputtering cathode. All by-pass and cooling cylinders are part of the rolling up system and are assembled on said structure 12. While FIG. 1 indicates positions of some by-pass cylinders of more reduced diameter, these were not reproduced in FIGS. 2 and 3, for better visibility. Only two cylinders are being shown there, i.e. an (upper) rolling up or unwinding cylinder 17 and the cooling or coating cylinder, placed underneath.

FIG. 2 shows structure 12 in its extracted position, where the entire plant, i.e. the entire housing 1, is being ventilated.

FIG. 3 shows the operating position of structure 12, introduced into housing 1. In the following, only one winding up station will subsequently be described; the second winding up station is structured in a function similar as described. This station is located in FIGS. 2 and 3, hidden in the visual direction behind the winding up station/cylinder 17; in FIGS. 1 and 5, both can be seen.

The trajectory of intersection of FIGS. 2 and 3 is indicated in FIG. 1 by dots and lines, with multiple breaks. The separating wall between both winding up stations 17 in FIG. 1 is not functionally required and may eventually be abandoned, when it is not intended to ventilate both winding up stations in a reciprocally independent manner. FIG. 1 features a cut, both traversing said housing 1, as well as structure 12 contained therein, with integrated cylinders.

The band substrate to be coated will be conducted from an unrolling cylinder 17 towards the coating cylinder underneath and through processing station B. The latter may evidently also comprise different sputtering cathodes. Subsequently, said substrate is being conducted upwards, to be received by winding up cylinder (as can also be seen in FIG. 1).

On the upper, inner wall 6 (above winding up station 10) of housing 1, at least one opening 7 is provided, normally closed with a chamber cover 8. This is provided at the border of inner wall 6, surrounding opening 7, being safely sealed by means of a circumferential seal 9. As can be seen in FIG. 1, for each winding up station, a separate opening 7 is provided with chamber cover 8 and seal 9.

From the same, plane inner wall 6, is also formed the inner opening (on the chamber side) of a pump socket, not shown here.

Advantageously, said chamber cover 8 may be opened with winding up stations in the introduced position.

Support 12 bears a plate-like base 11, closed and pertaining to winding up station 10. It also comprises an upper opening 13, as well as an “active” seal 14, circumferentially surrounding it and preferentially inflatable with fluid pressure, a closed (resistance) mounting plate 15, two sockets 16 for substrate spools or bales, firmly disposed at base 11 and at the mounting plate 15, and lastly a substrate spool 17, rotably applied upon said sockets 16. The coating cylinder, provided underneath, is mounted on specific mounting sockets, independently from the unwinding cylinder.

Seal 14 is provided on a flange surrounding opening 13; the fluid pressure connections, required for operation, are not being shown here to simplify the view. Preferentially, said seal will be provided inside a surrounding groove of said flange, in order to be safely protected against mechanical damages, when not being actively used.

Base 11 and mounting plate 15 comprise a closed side wall of structure 12. The upper section of structure 12 forms, as a whole, a chamber essentially closed, surrounding said substrate spool 17, said chamber offering access only through opening 13.

FIG. 3 shows functional details of seal 14, which has been inflated after introduction of structure 12 inside housing 1, and being in a juxtaposed position around opening 13 at the inner wall 6 of said housing. It can also be seen that the border of the plate-like basis 11, in the final or operating position of said winding up station 10, rests circumferentially upon flange 3 of said opening 5 of housing 1, closing it and its inner surface is propped up against seal 4. Therefore, said opening 5 is tightly closed and base 11 forms, in this position, a wall of said housing 1.

Underneath said counter-plate 15, FIG. 3 indicates a console 1K, upon which said structure 12, i.e. its chamber, may be supported inside housing 1, in case of need. Different from this strongly simplified representation, such a support may also be provided with corresponding counter pieces at structure 12 in the form of a guiding rail or similar device inside housing 1, as well as on the counter plate 15, and, therefore, the entire set of cylinders is being supported not only in the introduced condition, but also during each extraction and introduction step.

Opening 13 in structure 12 of said winding up station 10 is sufficiently large, being thus positioned that it overlaps opening 7 of inner wall 6 with the chamber cover 8. Consequently, inflatable seal 12 also surrounds said opening 7.

Differently from the representation, seal 14 could basically also be provided at said inner wall 6 of housing 1, on the same spot, in order to be juxtaposed at the flange surrounding opening 13 of structure 12, in inflated condition.

Before commissioning processing plant and after correct fixation of structure 12 inside housing 1, the latter will be evacuated by air suction by means of pumps (not shown). Seal 14 may be applied against the plane inner wall 6 of housing 1 (sealed position), applying pressure thereupon over said fluid connections, not shown.

Nevertheless, it does not have to be constantly “activated” during normal operation of said processing plant, since housing 1 encompasses both the winding up stations as well as the processing station, which are therefore simultaneously evacuated. Seal 14 will only be effectively required when it is intended to ventilate winding up station 10 independently from the remaining housing 1, i.e. when it is intended to open the chamber cover(s) 8.

During the moving phases of winding up station 10 relative to housing 1—i.e. not in operational status of plant, for example during maintenance or cleaning operations, which cannot be simply accomplished after opening a chamber cover 8—or with completely evacuated housing 1, (including winding up chamber 10), said seal 14 will be distended (its inner pressure will be neutralized) or it will be exposed to lower sub-pressure. As a consequence, it will be largely retracted into its seat groove (retracted position), where it is protected against friction and damages.

As can be seen in the comparison of FIGS. 2 and 3, movements of structure 12 relative to housing 1 are parallel to the axis of winding up station 10 or of substrate spool 17, respectively.

Underneath said substrate spool 17, a band substrate 17S is being conducted from unwinding station 10 in structure 12, in a downward direction in processing module B. The corresponding opening of winding up chamber or of winding up station 10, may be locked by an air-lock valve 18 vis-à-vis said housing 1 and processing station B. Said air-lock valve is provided inside said moveable structure 12; during opening and extraction of structure 12, it will consequently be removed from housing 1.

The air-lock valve 18 renders it possible to exchange the substrate supports- or spools 17, existing inside winding up stations 10, without having to ventilate housing 1 altogether. As will be later described, in its closed position, said air-lock valve 18 locks without any gaps said processing station B against winding up station 10. It is designed as a static valve, which, during plant operation, offers a relatively large free transversal section, through which said band substrate may pass free of contact.

FIG. 4 shows, separately, an angled view of an winding up station 10. This also indicates that opening 7 of housing 1, closed by chamber cover 8, is sufficiently large to exchange, i.e. to lift, substrate spool 17 after opening of chamber cover 8, without displacing winding up station vis-à-vis housing 1, introducing a new substrate spool.

In this view, it may again be well recognized how the flexible substrate 17S which may be removed from substrate spool 17, is transferred from structure 12 into processing module B, provided underneath the winding up station, by means of (at least) one by-pass cylinder and through air-lock valve 18, also indicated only schematically. Said air-lock valve is firmly mounted on structure 12.

Structure 12 of winding up stations 10 forms, thus, as already mentioned, a chamber which is surrounded by the common basis 11 and mounting plate 15 (FIGS. 4 and 5), by means of another bottom section, with an opening receiving said air-lock valve 18, as well as with the side walls, which here may be seen at the right and left sides of said substrate spool 17.

This chamber may be accessed both externally through opening 7, closed by chamber cover 8 and circumferentially sealed by seal 14, also when it is in operational condition inside housing 1 of said processing plant.

Also opposed to winding up station 10 according to FIG. 4, beyond (downwards) from processing module B, another similar winding up station (not shown here) is provided, which may be imagined in a specular position vis-à-vis winding up station 10, including the possibility to remove and eventually replace the substrate spool, therein enclosed through an opening from housing 1

It can be provided that the winding up stations 10 may be opened and ventilated independently from each other, i.e. whilst one unit is being ventilated, the other may remain evacuated (in this case, the separating wall, shown in FIG. 1, is naturally required for operation), or basically both winding up stations may be jointly ventilated. In the latter case, they do not have to be separately sealed against each other.

This second winding up station 10, corresponding to the principle of FIG. 1, is provided inside the same structure 12 and therefore has a stable position in relation to winding up station 10. Consequently, both units may be jointly removed from housing 1 by means of structure 12—after opening seal 14.

During operation, said air-lock valve 18 is capable to safely eliminate considerable pressure differentials, for example between atmospheric pressure and vacuum.

It may, however, also be opening, on one side, in order to enable free passage and substrate flux, and, on the other side, in order to render feasible traversing i.e. introduction of new substrates, when the previously processed, flexible substrate has been completely removed from the plant. Evidently, the opening width of valve will be sized in a measure adjusted to the sizes (especially the width) of the substrate to be processed.

Lastly, by means of the air-lock valve 18, terminal sections of the finished band sub-strate may be retained, in order to fix new band substrates in known fashion on said terminal sections and subsequently—instead of complex manual introduction procedures—to introduce and traverse the new band substrate by means of the “old” remaining segment.

It would, thus, basically be possible to design the air-lock valves in the same fashion as outlined in WO-A1 99/50472 above. However, other embodiments may be used. An exemplary embodiment will be schematically explained, based on FIG. 5.

Consequently, said air-lock valves 18 are quite essential for the above described option to exchange substrate spools without complete extraction of unwinding station(s) 10. They render feasible, in closed condition, to open said chamber cover 8, without similarly ventilating processing module B then evacuated.

FIG. 5 shows another embodiment of the processing plant according to the invention, comprising two winding up stations in a compact, common structure 12″ in a winding up module 10′, in tandem disposition. This offers the advantage that both substrate spools 17 may be accessed through a common chamber cover 8′, so that also in housing 1 only one opening has to be provided and sealed. Also the circumferential seal 14 may be provided, in this design, commonly for both winding up stations and eventually in more simple fashion.

Additionally, both air-lock valves 18 may be joined here to compose one built unit 18′, although evidently for each extracting and introducing substrate section, a specific/independent valve function has to be provided.

FIG. 6, finally, features a cut through an embodiment of an air-lock valve 18 which may be preferably used in the context of the continuous unit described herein. One recognizes substrate 17S which traverses said air-lock valve 18 and, in a closer sense, an opening 19 (slit-like) which may be closed by it. Also part of said valve 18 is a cylinder-shaped valve body 21, rotably mounted inside its housing or structure around an axis 20 between the shown closed position and an opened position, represented by dotted lines. Nevertheless, said cylinder body 21 could roll on said substrate 17S, but it is foreseen that in the continuous operation of the processing plant, said valve body 21 does not contact substrate 17S. To clarify this point, also the approximate trajectory of said substrate 17S with opened valve 18 is indicated with dotted lines. Nevertheless, at the expelled and finished/coated substrate section, frictional contact with plant components should possibly be avoided (at known plants, valves are therefore only being provided occasionally with minimum air gaps).

It can be seen that the face inside the housing, turned toward the valve body 21, where opening 19 ends, is formed in such a fashion that substrate 17S between border section of said opening (which simultaneously may serve or be formed as a sealing surface 22) and the valve body 21 transferred in the closed position, may be mounted in paralyzed condition without being exclusively bent in the process. Surface 22, directed towards the sealing edge, is applied obliquely towards the band substrate plane. Also sealing surface 22, which may be closed by valve body 21, eventually with substrate 17S in an intermediate position, is designed in such a fashion at opening 19 (eventually using soft and elastic materials as edge or surface seals) that a satisfactory sealing effect remains insured, independently whether valve body 21 is being forcibly applied separately or jointly with substrate.

Preferably, said air-lock valve 18 will be provided in structure 12 or 12′ as separate module. This applies especially also for the fusion into one valve block, shown in FIG. 4, of two air-lock valves, which may be operated independently from each other.

As already outlined above, this embodiment enables, on one side, with substrate still remaining inside the plant, to ventilate said winding up stations 10 or 10′, whilst processing module B remains evacuated, and, on the other side, after exchange of substrate spools, the new band substrate may be introduced by means of the remaining band section, fixed in the valves. For this purpose, the initial section of the new band substrate will be glued with the remaining band section.

1. A continuous processing plant for processing flexible substrates, said continuous processing plant comprising:
two winding up stations, each said winding up station adapted for unrolling and winding up of a flexible substrate;
at least one processing station, said at least one processing station being provided in the passage of said flexible substrate between said two winding up stations; and
two valves, each said valve integrated between separate ones of said winding up stations and said at least one processing station, said valves adapted to enable different pressure levels in said winding up stations and said at least one processing station;
said winding up stations being provided on a moveable base and adapted to being selectively extracted from said continuous processing plant;
said at least one processing station being disposed in or upon a fixed base designed as part of a housing, said housing surrounding said at least one processing station and said housing further surrounding said winding up stations and containing said valves when said continuous processing plant is in operational status;
said winding up stations being provided inside a structure involving said movable base, said structure featuring openings lockable by said valves and adapted to being integrated inside said housing when said continuous processing plant is in operational status;
and in the opened condition of said valves, both said at least one processing station and said winding up stations may be jointly evacuated and, in the closed status of said valves, said winding up stations may be ventilated independently from said at least one processing station.

2. The continuous processing plant according to claim 1, wherein said base of said winding up stations forms a wall of said structure.

3. The continuous processing plant according to claim 2, wherein said base of said winding up stations forms at least a wall section of said housing when said continuous processing plant is in operational status.

4. The continuous processing plant according to claim 1, wherein said structure of said winding up stations forms at least one chamber, said at least one chamber being at least partially defined by said movable base, a mounting plate, and side walls, said chamber being provided with at least one chamber opening.

5. The continuous processing plant according to claim 4, wherein said housing includes at least one loading and/or unloading housing opening for at least one of said winding up stations, said at least one housing opening adapted to being locked by a chamber cover.

6. The continuous processing plant according to claim 5, wherein said windings up stations include substrate supports, and wherein when said structure is located inside said housing said at least one chamber opening of said structure is aligned with said at least one housing opening in order to enable an exchange of said substrate supports after opening of said chamber cover.

7. The continuous processing plant according to claim 6, wherein said at least one chamber opening is surrounded by a seal, said seal adapted to being applied between said housing and a border of said at least one chamber opening.

8. The continuous processing plant according to claim 7, wherein said seal is adapted to be applied against a plane inner wall of said housing.

9. The continuous processing plant according to claim 7, wherein said seal is adapted to be controlled by fluid pressure, wherein said seal is adapted to be pressurized in a sealing position and is adapted to be depressurized in a retracted position.

10. The continuous processing plant, according to claim 7, wherein said continuous processing plant is adapted to be evacuated in the area surrounded by said seal.

11. The continuous processing plant according to claim 1, wherein at least one of said valves comprises an air-lock valve provided at said structure of said winding up stations.

12. The continuous processing plant according to claim 11, wherein said air-lock valve comprises a sealing surface surrounding in frame-like fashion an opening provided for passage of said flexible substrate, and wherein said air-lock valve further comprises a body for closing said opening of said air-lock valve, said body adapted to be selectively pressed upon at least one of said sealing surface and said flexible substrate extending through said opening of said air-lock valve such that said body obstructs said opening of said air-lock valve at said sealing surface.

13. The continuous processing plant according to claim 12, wherein said flexible substrate may be selectively firmly held inside said opening of said air-lock valve by said body to enable introduction of a new substrate via said flexible substrate held by said air-lock valve.

14. The continuous processing plant according to claim 1, wherein said valves are separately formed and secured to said structure, and wherein said two valves are selected from the group consisting of independent separate valves and a single unitary arrangement of valves.

15. A continuous processing plant for processing flexible substrates, said continuous processing plant comprising:
two winding up stations, each said winding up station adapted for unrolling and winding up of a flexible substrate;
at least one processing station, said at least one processing station being provided in the passage of said flexible substrate between said two winding up stations; and
two valves, each said valve integrated between separate ones of said winding up stations and said at least one processing station, said valves adapted to enable different pressure levels in said winding up stations and said at least one processing station;
said winding up stations being provided on a moveable base and adapted to being selectively extracted from said continuous processing plant;
said at least one processing station being disposed in or upon a fixed base designed as part of a housing, said housing surrounding said at least one processing station and said housing further surrounding said winding up stations and containing said valves when said continuous processing plant is in operational status;
said winding up stations being provided inside a structure involving said movable base, said structure featuring openings lockable by said valves and adapted to being integrated inside said housing when said continuous processing plant is in operational status;
and in the opened condition of said valves, both said at least one processing station and said winding up stations may be jointly evacuated and, in the closed status of said valves, said winding up stations may be ventilated independently from said at least one processing station;
said structure of said winding up stations forming two chambers, each said winding up station being located within a separate said chamber and each said chamber being provided with a chamber opening, each said chamber being adapted to be evacuated independently from the other said chamber.

16. The continuous processing plant according to claim 15, wherein said housing includes two housing openings and two chamber covers, each said housing opening adapted to being locked by one of said chamber covers.

17. The continuous processing plant according to claim 16, wherein said winding up stations include substrate supports, and wherein when said structure is located inside said housing said chamber openings are aligned with said housing openings such that said substrate supports are selectively removable after opening said chamber covers.

18. The continuous processing plant according to claim 17, wherein said chamber openings are surrounded by at least one seal, said at least one seal adapted to being applied against said housing when said structure is located inside said housing.

19. The continuous processing plant according to claim 18, wherein said at least one seal is adapted to be controlled by fluid pressure, wherein said seal is adapted to be pressurized in a sealing position and is adapted to be depressurized in a retracted position.
